(19) United States
(12) Patent Application Publication
(10) Pub. No.: US 2022/0137754 A1
(43) Pub. Date: May 5, 2022

(54) TOUCH POSITIONING METHOD AND APPARATUS

(71) Applicants: Beijing BOE Display Technology Co., Ltd., Beijing (CN); BOE Technology Group Co., Ltd., Beijing (CN)

(72) Inventors: Xinle WANG, Beijing (CN); Wei SUN, Beijing (CN); Wenchao HAN, Beijing (CN); Xiaofeng YIN, Beijing (CN); Lianghao ZHANG, Beijing (CN); Yilin FENG, Beijing (CN); Zhengri LIN, Beijing (CN); Xinqiu WANG, Beijing (CN); Mingming WANG, Beijing (CN)

(21) Appl. No.: 17/258,144

(22) PCT Filed: Mar. 24, 2020
(86) PCT No.: PCT/CN2020/080984

§ 371 Date: Jan. 5, 2021

(51) Int. Cl. G06F 3/044

(52) U.S. Cl. CPC G06F 3/0446

(57) ABSTRACT

This disclosure provides a touch positioning method and apparatus. The touch positioning method includes: acquiring capacitance values and position coordinates of each first touch electrode and each second touch electrode in a touch screen; for the each second touch electrode, judging whether a capacitance value of the second touch electrode is greater than a first threshold; determining second touch electrodes as target second touch electrodes when judging that capacitance values of the second touch electrodes each is greater than the first threshold; and determining target touch position coordinates according to the capacitance values and position coordinates of the target second touch electrodes as well as capacitance values and position coordinates of first touch electrodes adjacent to the target second touch electrodes.

### CROSS REFERENCE TO RELATED DOCUMENTS

The present application is a national phase entry under 35 U.S.C. § 371 of International Application No. PCT/CN2020/080984, filed on Mar. 24, 2020.

### FIELD

This disclosure relates to the field of touch technology, and in particular to a touch positioning method and apparatus.

### BACKGROUND

With the development of touch technology, the touch screen with touch function is, as an information input tool, widely used in various display products such as mobile phones, tablet computers, and information inquiry machines in public halls. A user only needs to touch the touch screen with a finger or a stylus to realize the operation of the electronic device with the touch screen, eliminating the user's dependence on other devices (such as keyboard and mouse), and making the human-computer interaction easier. However, how to improve the touch accuracy is a technical problem to be solved urgently by those skilled in the art.

### BRIEF SUMMARY

Embodiments of the disclosure provide a touch positioning method, including:

acquiring capacitance values and position coordinates of each first touch electrode and each second touch electrode in a touch screen;

for the each second touch electrode, judging whether a capacitance value of the second touch electrode is greater than a first threshold;

determining second touch electrodes as target second touch electrodes when judging that capacitance values of the second touch electrodes each is greater than the first threshold; and

determining target touch position coordinates according to the capacitance values and position coordinates of the target second touch electrodes as well as capacitance values and position coordinates of first touch electrodes adjacent to the target second touch electrodes.

Optionally, in some embodiments of the disclosure, the determining target touch position coordinates according to the capacitance values and position coordinates of the target second touch electrodes as well as capacitance values and position coordinates of first touch electrodes adjacent to the target second touch electrodes, includes:

among the first touch electrodes adjacent to the target second touch electrodes, determining first touch electrodes with capacitance values each greater than the first threshold as target first touch electrodes; and

determining the target touch position coordinates according to the capacitance values and position coordinates of the target second touch electrodes as well as capacitance values and position coordinates of the target first touch electrodes.

Optionally, in some embodiments of the disclosure, the determining the target touch position coordinates according to the capacitance values and position coordinates of the target second touch electrodes as well as the capacitance values and position coordinates of the target first touch electrodes, includes:

among the target second touch electrodes, determining a target second touch electrode with a capacitance value greater than a second threshold as a first sub-target second touch electrode, and determining a target second touch electrode with a capacitance value not greater than the second threshold as a second sub-target second touch electrode; wherein the second threshold is greater than the first threshold;

among target first touch electrodes adjacent to the first sub-target second touch electrode, determining a target first touch electrode with a capacitance value not greater than the second threshold as a first sub-target first touch electrode; and among target first touch electrodes adjacent to the second sub-target second touch electrode, determining a target first touch electrode with a capacitance value greater than the first threshold as a second sub-target first touch electrode; and

determining the target touch position coordinates according to the capacitance value and position coordinates of the first sub-target second touch electrode, the capacitance value and position coordinates of the first sub-target first touch electrode, the capacitance value and position coordinates of the second sub-target second touch electrode, and the capacitance value and position coordinates of the second sub-target first touch electrode.

Optionally, in some embodiments of the disclosure, the capacitance value of the first sub-target second touch electrode is a maximum value among capacitance values of the target second touch electrodes.

The determining the target touch position coordinates according to the capacitance value and position coordinates of the first sub-target second touch electrode, the capacitance value and position coordinates of the first sub-target first touch electrode, the capacitance value and position coordinates of the second sub-target second touch electrode, and the capacitance value and position coordinates of the second sub-target first touch electrode, includes:

dividing the first sub-target second touch electrode equally into a plurality of first split second touch electrodes and dividing the second sub-target second touch electrode equally into a plurality of second split second touch electrodes according to a proportional relationship between second touch electrodes and first touch electrodes in the touch screen; wherein first split second touch electrodes in the same first sub-target second touch electrode are arranged in an extension direction of the second touch electrodes, and second split second touch electrodes in the same second sub-target second touch electrode are arranged in the extension direction of the second touch electrodes;

selecting position coordinates of a first set position in a first target area formed by the first sub-target second touch electrode and the first sub-target first touch electrode as first initial coordinates (x01, y01);

determining first intermediate coordinates (X01′, Y01′) by using a following first formula group according to the first initial coordinates (x01, y01); wherein (x1ᵢ, y1ᵢ) represents i^{th} center position coordinates in the total number formed by all the first sub-target first touch electrodes, all the second sub-target first touch electrodes, all the first split second touch electrodes and all the second split second touch electrodes; D1ᵢ represents a distance between the i^{th} center position coordinates and the first initial coordinates, and S1ᵢ represents the i^{th} capacitance value;

$$D {1}_{i} = \sqrt{{( x {1}_{i} - {x}_{01} )}^{2} + {( y {1}_{i} - {y}_{01} )}^{2}} ;$$

$$X {01}^{′} = \frac{{\sum }_{i = 1}^{I} \frac{S {1}_{i}}{D {1}_{i}} * x {1}_{i}}{{\sum }_{i = 1}^{I} \frac{S {1}_{i}}{D {1}_{i}}} ;$$

$$Y {01}^{′} = \frac{{\sum }_{i = 1}^{I} \frac{S {1}_{i}}{D {1}_{i}} * y {1}_{i}}{{\sum }_{i = 1}^{I} \frac{S {1}_{i}}{D {1}_{i}}} ;$$

updating the first initial coordinates (x01, y01) according to the determined first intermediate coordinates (X01′, Y01′); and determining new first intermediate coordinates (X01′, Y01′) according to the updated first initial coordinates (x01, y01) by using the first formula group; and updating the first initial coordinates (x01, y01) according to the determined new first intermediate coordinates (X01′, Y01′) until update times satisfy an update threshold, and taking the last updated first initial coordinates (x01, y01) as the target touch position coordinates.

Optionally, in some embodiments of the disclosure, the position coordinates of the first set position are center position coordinates of the first target area.

Optionally, in some embodiments of the disclosure, the determining the target touch position coordinates according to the capacitance values and position coordinates of the target second touch electrodes as well as the capacitance values and position coordinates of the target first touch electrodes, includes:

among the target second touch electrodes, determining a target second touch electrode with a maximum capacitance value as a third sub-target second touch electrode; and

determining the target touch position coordinates according to the capacitance value and position coordinates of the third sub-target second touch electrode as well as capacitance values and position coordinates of target first touch electrodes adjacent to the third sub-target second touch electrode.

Optionally, in some embodiments of the disclosure, the determining the target touch position coordinates according to the capacitance value and position coordinates of the third sub-target second touch electrode as well as the capacitance values and position coordinates of a target first touch electrodes adjacent to the third sub-target second touch electrode, includes:

among the target first touch electrodes adjacent to the third sub-target second touch electrode, determining a target first touch electrode with a capacitance value greater than the first threshold and less than a second threshold as a third sub-target first touch electrode; and

determining the target touch position coordinates according to the capacitance value and position coordinates of the third sub-target second touch electrode as well as the capacitance value and position coordinates of the third sub-target first touch electrode.

Optionally, in some embodiments of the disclosure, the determining the target touch position coordinates according to the capacitance value and position coordinates of the third sub-target second touch electrode as well as the capacitance value and position coordinates of the third sub-target first touch electrode, includes:

dividing the third sub-target second touch electrode equally into a plurality of third split second touch electrodes according to a proportional relationship between second touch electrodes and first touch electrodes in the touch screen; wherein third split second touch electrodes in the same third sub-target second touch electrode are arranged in an extension direction of the second touch electrodes;

selecting position coordinates of a second set position in a second target area formed by the third sub-target second touch electrode and the third sub-target first touch electrode as second initial coordinates (x02, y02);

determining second intermediate coordinates (X02′, Y02′) by using a following second formula group according to the second initial coordinates (x02, y02); wherein (x1n, y1n) represents n^{th} center position coordinates in the total number formed by all the third sub-target first touch electrodes and all the third split second touch electrodes, Din represents a distance between the n^{th} center position coordinates and the second initial coordinates, and S in represents the n^{th} capacitance value;

$$D {1}_{n} = \sqrt{{( x {1}_{n} - {x}_{02} )}^{2} + {( y {1}_{n} - {y}_{02} )}^{2}} ;$$

$$X {02}^{′} = \frac{{\sum }_{n = 1}^{N} \frac{S {1}_{n}}{D {1}_{n}} * x {1}_{n}}{{\sum }_{n = 1}^{N} \frac{S {1}_{n}}{D {1}_{n}}} ;$$

$$Y {02}^{′} = \frac{{\sum }_{n = 1}^{N} \frac{S {1}_{n}}{D {1}_{n}} * y {1}_{n}}{{\sum }_{n = 1}^{N} \frac{S {1}_{n}}{D {1}_{n}}} ;$$

updating the second initial coordinates (x02, y02) according to the determined second intermediate coordinates (X02′, Y02′); and determining new second intermediate coordinates (X02′, Y02′) according to the updated second initial coordinates (x02, y02) by using the second formula group; and updating the second initial coordinates (x02, y02) according to the determined new second intermediate coordinates (X02′, Y02′) until update times satisfy an update threshold, and taking the last updated second initial coordinates (x02, y02) as the target touch position coordinates.

Optionally, in some embodiments of the disclosure, the position coordinates of the second set position are center position coordinates of the second target area.

Embodiments of the disclosure further provides a touch positioning apparatus, including:

an acquisition circuit configured to acquire capacitance values and position coordinates of each first touch electrode and each second touch electrode in a touch screen;

a judgment circuit configured to, for the each second touch electrode, judge whether a capacitance value of the second touch electrode is greater than a first threshold;

a target electrode determining circuit configured to determine second touch electrodes as target second touch electrodes when judging that capacitance values of the second touch electrodes each is greater than the first threshold; and

a position coordinate determining circuit configured to determine target touch position coordinates according to the capacitance values and position coordinates of the target second touch electrodes as well as capacitance values and position coordinates of first touch electrodes adjacent to the target second touch electrodes.

Embodiments of the disclosure further provide a computer readable storage medium storing a computer program thereon. The computer program, when executed by a processor, implements the steps of the above touch positioning method.

Embodiments of the disclosure further provide a computer device including a memory, a processor and a computer program that is stored on the memory and capable to be run on the processor. The processor implements the steps of the above touch positioning method when executing the computer program.

### BRIEF DESCRIPTION OF THE DRAWINGS

FIG. 1 is a structural schematic diagram of a touch screen in some embodiments of the disclosure;

FIG. 2A is a flow chart of a touch positioning method in some embodiments of the disclosure;

FIG. 2B is a flow chart of a touch positioning method in some other embodiments of the disclosure;

FIG. 3 is a structural schematic diagram when a finger touches a touch screen in embodiments of the disclosure;

FIG. 4 is a structural schematic diagram of a touch screen in some other embodiments of the disclosure;

FIG. 5 is a schematic diagram of a partial structure of the touch screen in some embodiments of the disclosure;

FIG. 6A is a structural schematic diagram of a first sub-target second touch electrode in some embodiments of the disclosure;

FIG. 6B is a structural schematic diagram of a second sub-target second touch electrode in some embodiments of the disclosure;

FIG. 6C is a structural schematic diagram of a second sub-target second touch electrode in some other embodiments of the disclosure;

FIG. 6D is a structural schematic diagram of a second sub-target second touch electrode in some other embodiments of the disclosure;

FIG. 7 is a flow chart of a touch positioning method in some other embodiments of the disclosure;

FIG. 8 is a schematic diagram of a partial structure of the touch screen in some other embodiment of the disclosure;

FIG. 9 is a structural schematic diagram of a third sub-target second touch electrode in some embodiments of the disclosure;

FIG. 10 is a structural schematic diagram of a touch positioning apparatus in some embodiments of the disclosure.

### DETAILED DESCRIPTION OF THE EMBODIMENTS

In order to make the purposes, technical solutions and advantages of the disclosure clearer, the technical solutions in the embodiments of the disclosure will be described clearly and completely below in combination with the accompanying drawings of the embodiments of the disclosure. Obviously the described embodiments are a part of the embodiments of the disclosure but not all the embodiments. Also in the case of no conflict, the embodiments and the features therein in the disclosure can be combined with each other. Based upon the embodiments of the disclosure, all of other embodiments obtained by those ordinary skilled in the art without creative work pertain to the protection scope of the disclosure.

Unless otherwise defined, the technical or scientific terms used in the disclosure shall have the general meaning understood by those ordinary skilled in the art to which the disclosure belongs. The “first”, “second” and similar words used in the disclosure do not represent any order, number or importance, and are only used to distinguish different components. The word such as “include” or “contain” or the like means that the element or object appearing before this word encompasses the elements or objects and their equivalents listed after this word, without excluding other elements or objects. The word such as “connect” or “connected” or the like is not limited to the physical or mechanical connection, but can include the electrical connection, whether direct or indirect.

It is necessary to note that the size and shape of each diagram in the accompanying drawings do not reflect the true proportion, and are merely for purpose of schematically illustrating the content of the disclosure. Also, the same or similar reference numbers represent the same or similar elements or the elements having the same or similar functions all the way.

In practical applications, the mutual-capacitance technology can be used, so that the touch screen uses the mutual-capacitance technology to realize the touch function. The self-capacitance technology can also be used, so that the touch screen uses the self-capacitance technology to realize the touch function. The 3D touch capacitance technology can also be used, so that the touch screen uses the 3D touch capacitance technology to realize the touch function.

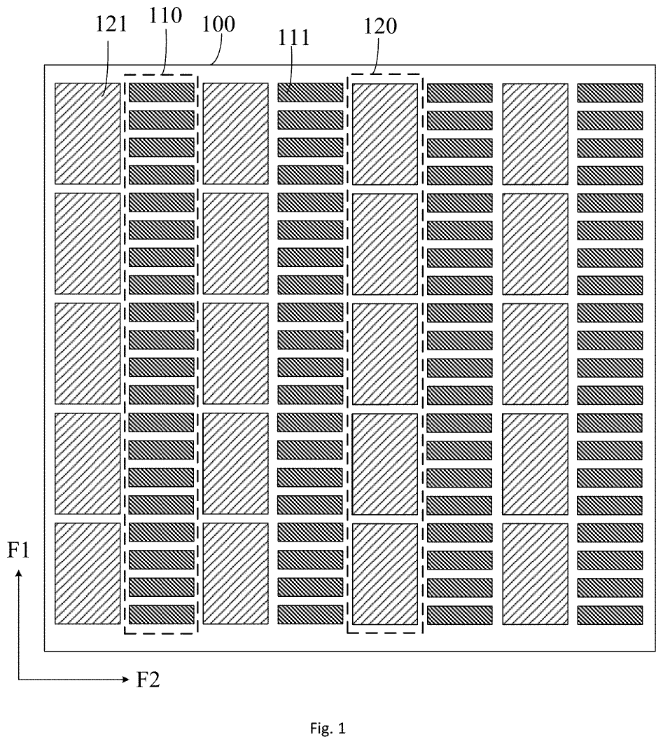

As shown in FIG. 1, it shows a touch screen that uses the mutual-capacitance technology to realize the touch function. The touch screen may include: a substrate 100, and a plurality of first touch electrode columns 110 and a plurality of second touch electrode columns 120 on the substrate 100. The second touch electrode columns 120 and the first touch electrode columns 110 are alternately arranged in the second direction F2. Exemplarily, the second touch electrode column 120 may include a plurality of second touch electrodes 121 arranged at intervals, and in the same second touch electrode column 120, all the second touch electrodes 121 extends in the first direction F1 and are arranged in the first direction F1. The first touch electrode column 110 may include a plurality of first touch electrodes 111 arranged at intervals, and in the same first touch electrode column 110, all the first touch electrodes 111 extends in the second direction F2 and are arranged in the first direction F1. Also, for each pair of adjacent second touch electrode column 120 and first touch electrode column 110, one second touch electrode 121 corresponds to a plurality of first touch electrodes 111. For example, FIG. 1 illustrates that one second touch electrode 121 corresponds to four first touch electrodes 111. In practical applications, the area of all the second touch electrodes 121 may be larger than the area of all the first touch electrodes 111. Or, the area of all the second touch electrodes 121 may be approximately equal to the area of all the first touch electrode 111.

Moreover, it should be noted that the touch screen is further provided with a driving circuit, and a plurality of first transmission lines and a plurality of second transmission lines electrically connected to the driving circuit. One second touch electrode 121 is electrically connected to one second transmission line, so as to realize the signal transmission between the driving circuit and the second touch electrode 121 through the second transmission line. And, one first touch electrode 111 is electrically connected to one first transmission line, so as to realize the signal transmission between the driving circuit and the first touch electrode 111 through the first transmission line.

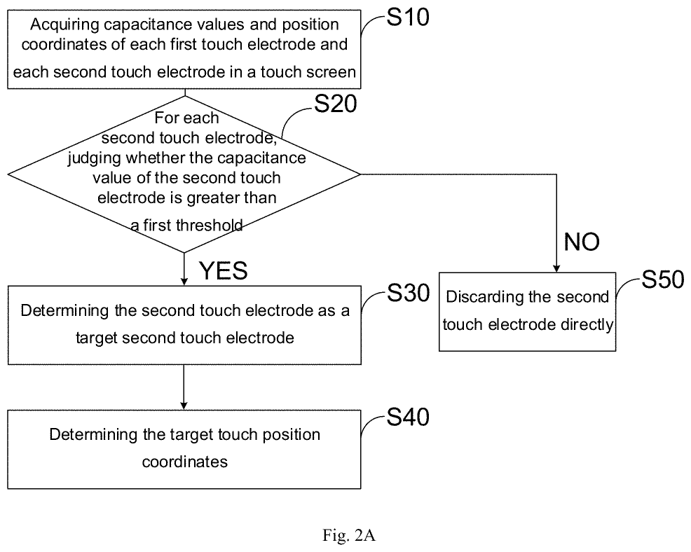

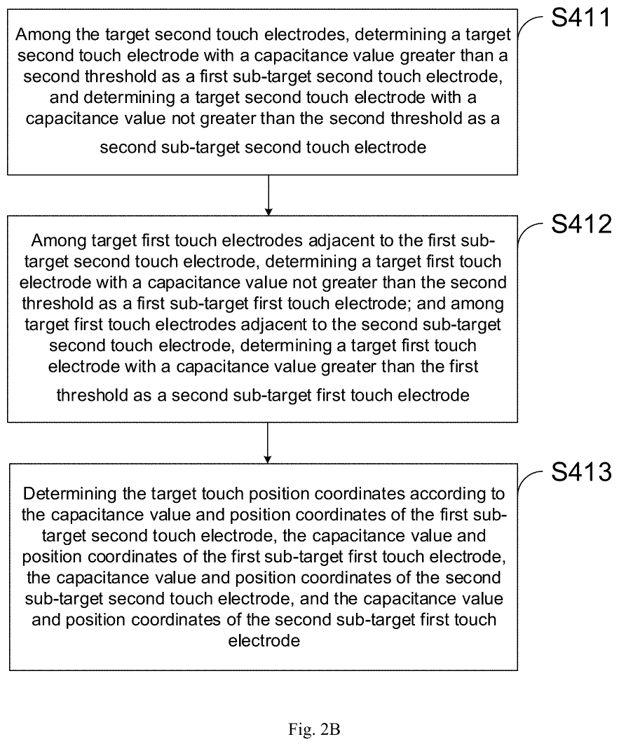

A touch positioning method provided by some embodiments of the disclosure, as shown in FIG. 2A, may include the following steps.

S10 is of acquiring the capacitance values and position coordinates of each first touch electrode and each second touch electrode in a touch screen.

S20 is of for each second touch electrode, judging whether the capacitance value of the second touch electrode is greater than a first threshold. Step S30 is performed when it is judged that the capacitance value of the second touch electrode is greater than the first threshold, and step S50 is performed when it is judged that the capacitance value of the second touch electrode is not greater than the first threshold.

S30 is of determining the second touch electrode as a target second touch electrode.

S40 is of determining the target touch position coordinates according to the capacitance value(s) and position coordinates of the target second touch electrode(s) as well as the capacitance values and position coordinates of first touch electrodes adjacent to the target second touch electrode(s).

S50 is of discarding the second touch electrode directly.

In the above touch positioning method provided by the embodiments of the disclosure, the capacitance values and position coordinates of each first touch electrode and each second touch electrode in the touch screen can be acquired, and for each second touch electrode, the second touch electrode may be determined as the target second touch electrode when judging that the capacitance value of the second touch electrode is greater than the first threshold. Thus, the second touch electrode that has a greater contribution to touch can be prioritized without taking all the second touch electrodes into consideration, thereby reducing the amount of calculations. In this way, the target touch position coordinates touched actually can be determined according to the capacitance value(s) and position coordinates of the target second touch electrode(s) as well as the capacitance values and position coordinates of the first touch electrodes adjacent to the target second touch electrode(s). Therefore, in the embodiments of the disclosure, the target touch position coordinates touched actually can be determined according to a part of the first touch electrodes and a part of the second touch electrodes, thereby reducing the amount of calculations and reducing the power consumption.

It should be noted that the capacitance values on the first touch electrodes and the second touch electrodes will be changed when the touch body touches the touch screen. Therefore, the position coordinates of each first touch electrode can be obtained by detecting the change of the capacitance value of the each first touch electrode. And the position coordinates of each second touch electrode are obtained by detecting the change of the capacitance value of the each second touch electrode. For example, the methods in the related art may be used to determine the position coordinates of the first touch electrodes and the second touch electrodes.

Generally, a finger is used to touch the touch screen for touch operation. Exemplarily, the touch body in the embodiments of the disclosure may be set as a finger. Of course, in practical applications, the touch body may also be set as other objects that can perform touch operations, which is not limited here.

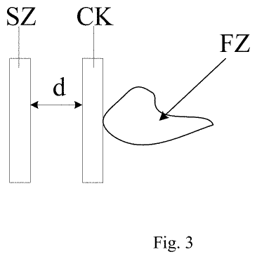

In practical applications, an equivalent plate capacitor is formed between a touch electrode and the ground. As shown in FIG. 3, one electrode CK in the plate capacitor is a touch electrode (for example, it may be a first touch electrode or second touch electrode), and the other electrode SZ is the ground. When a conductive touch body is used to touch the touch screen, a capacitance is connected in parallel with the plate capacitor, so that the total capacitance on the plate capacitor is changed. Taking the touch body being a finger FZ as an example, when the finger touches the touch screen, the finger and the touch electrode may also form a capacitance, and the capacitance formed by the finger and the touch electrode is connected in parallel to the above plate capacitor. Therefore, by detecting the capacitance value after the capacitance formed by each touch electrode and the ground is connected in parallel with the capacitance formed by the touch electrode and the finger, the detected capacitance value can be used as the touch capacitance value of the touch electrode. For example, by detecting the capacitance value after the capacitance formed by each first touch electrode and the ground is connected in parallel with the capacitance formed by the first touch electrode and the finger, the detected capacitance value can be used as the touch capacitance value of the first touch electrode. And, by detecting the capacitance value after the capacitance formed by each second touch electrode and the ground is connected in parallel with the capacitance formed by the second touch electrode and the finger, the detected capacitance value can be used as the touch capacitance value of the second touch electrode.

And, the calculation formula of the capacitance value of the plate capacitor is C=εS/d, here ε represents the dielectric constant between two electrodes of the plate capacitor, S represents the facing area between the two electrodes of the plate capacitor, and d represents the distance between the two electrodes of the plate capacitor. In practical applications, when a finger touches the touch screen, the distances between the finger and the touch electrodes may be regarded as approximately the same. Therefore, if the areas of the touch electrodes are different, the detected capacitance values of the equivalent plate capacitors between the touch electrodes and the finger will be different. For example, the area of a second touch electrode 121 is larger than the area of a first touch electrode 111 in FIG. 1, so that the capacitance value corresponding to the second touch electrode 121 is different from the capacitance value corresponding to the first touch electrode 111.

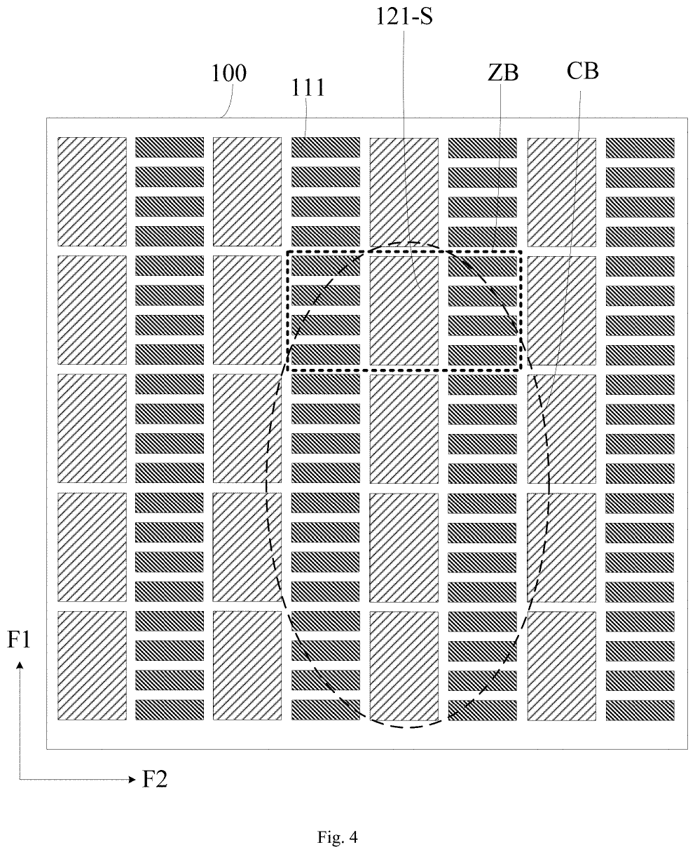

In practical applications, taking the touch body being a finger as an example, when the finger touches the touch screen, the finger will contact the touch screen, so that the area where the finger contacts the touch screen is mainly the touch area where the first touch electrodes and the second touch electrodes are operated. As shown in FIG. 4, CB represents the touch area formed when the finger touches the touch screen. Of course, the disclosure includes but not limited to this.

In a specific implementation, the touch electrodes in the embodiments of the disclosure may be the electrodes that use the mutual-capacitance technology to realize the touch function. Further, the touch screen is an in-cell display touch screen, that is to say, the touch screen may further realize the display function. In this way, the mutual-capacitance technology can be combined with the display technology, so that the display panel uses the mutual-capacitance technology to realize the touch function.

It should be noted that, for example, a touch body may be used to touch the touch screen, and when the touch body touches the touch screen, the capacitance value of each first touch electrode and the capacitance value of each second touch electrode in the touch screen are collected multiple times, then the sum of the capacitance values of the first touch electrodes and the capacitance values of the second touch electrodes collected each time is determined, and then the average value of the sums of the capacitance values collected multiple times is determined. For example, when the touch body touches the touch screen, the capacitance value of each first touch electrode and the capacitance value of each second touch electrode in the touch screen are collected for 30 times, and then the number of the determined sums of the capacitance values of the first touch electrodes and the capacitance values of the second touch electrodes is 30, i.e., V1 to V30. Here, V1 represents the sum of the capacitance values of all the first touch electrodes and the capacitance values of all the second touch electrodes collected for the first time, V2 represents the sum of the capacitance values of all the first touch electrodes and the capacitance values of all the second touch electrodes collected for the second time, and V3 represents the sum of the capacitance values of all the first touch electrodes and the capacitance values of all the second touch electrodes collected for the third time, and so on, V30 represents the sum of the capacitance values of all the first touch electrodes and the capacitance values of all the second touch electrodes collected for the 30^{th} time. Therefore, the average value is Vs=(V1+V2+V3+ . . . +V30)/30. In some embodiments of the disclosure, the first threshold may be set as 15%˜30% of the average value. For example, the first threshold may be set as 15% of the average value. The first threshold may also be set as 20% of the average value. The first threshold may also be set as 25% of the average value. The first threshold may also be set as 30% of the average value. Of course, in practical applications, the first threshold may be set based on experience, or may also be set based on the actual application requirements, which is not limited here.

In a specific implementation, in some embodiments of the disclosure, the first touch electrodes adjacent to the target second touch electrode(s) may refer to the first touch electrodes closest to the boundary of the target second touch electrode(s). With reference to FIG. 4, taking one second touch electrode and eight first touch electrodes in the area ZB as an example, if the capacitance value of the second touch electrode in the area ZB is greater than the first threshold, then the second touch electrode can be determined as the target second touch electrode 121-S, and the eight first touch electrodes in the area ZB are the first touch electrodes adjacent to the target second touch electrode 121-S.

In a specific implementation and in some embodiments of the disclosure, the determining target touch position coordinates according to the capacitance value(s) and position coordinates of the target second touch electrode(s) as well as the capacitance values and position coordinates of the first touch electrodes adjacent to the target second touch electrode(s), may include:

among the first touch electrodes adjacent to the target second touch electrode(s), determining first touch electrode(s) with capacitance value(s) greater than the first threshold as target first touch electrode(s); and

determining the target touch position coordinates according to the capacitance value(s) and position coordinates of the target second touch electrode(s) as well as the capacitance value(s) and position coordinates of the target first touch electrode(s).

In the above touch positioning method provided by the embodiments of the disclosure, among the first touch electrodes adjacent to each target second touch electrode, the first touch electrode(s) with the capacitance value greater than the first threshold is determined as the target first touch electrode(s), so that the first touch electrode(s) that has/have a greater contribution to touch can be prioritized without taking all the first touch electrodes into consideration, thereby further reducing the amount of calculations and reducing the power consumption.

In a specific implementation and in some embodiments of the disclosure, as shown in FIG. 2B, the determining the target touch position coordinates according to the capacitance values and position coordinates of the target second touch electrodes as well as the capacitance values and position coordinates of the target first touch electrodes, may include the following steps.

S411: among the target second touch electrodes, determining target second touch electrode(s) with capacitance value(s) greater than a second threshold as first sub-target second touch electrode(s), and determining target second touch electrode(s) with capacitance value(s) not greater than the second threshold as second sub-target second touch electrode(s). The second threshold is greater than the first threshold.

S412: among target first touch electrodes adjacent to the first sub-target second touch electrode(s), determining target first touch electrode(s) with capacitance value(s) not greater than the second threshold as first sub-target first touch electrode(s); and among target first touch electrodes adjacent to the second sub-target second touch electrode(s), determining target first touch electrode(s) with capacitance value(s) greater than the first threshold as second sub-target first touch electrode(s).

S413: determining the target touch position coordinates according to the capacitance value(s) and position coordinates of the first sub-target second touch electrode(s), the capacitance value(s) and position coordinates of the first sub-target first touch electrode(s), the capacitance value(s) and position coordinates of the second sub-target second touch electrode(s), and the capacitance value(s) and position coordinates of the second sub-target first touch electrode(s).

In this way, the target second touch electrodes and the target first touch electrodes can be classified through the first threshold and the second threshold, so that the target touch coordinates with higher touch accuracy can be determined to improve the touch accuracy.

It should be noted that the second threshold may be set as 40% to 60% of the above average value. For example, the second threshold may be set as 40% of the average value. The second threshold may also be set as 45% of the average value. The second threshold may also be set as 50% of the average value. The second threshold may also be set as 55% of the average value. The second threshold may also be set as 60% of the average value. Of course, in practical applications, the second threshold may be set based on experience, or may also be set based on the actual application requirements, which is not limited here.

In a specific implementation and in some embodiments of the disclosure, the capacitance value of the first sub-target second touch electrode(s) may be the maximum value among capacitance values of the target second touch electrodes. That is to say, the target second touch electrode(s) corresponding to the maximum value among the capacitance values of the target second touch electrodes can be filtered out by the second threshold. The filtered-out target second touch electrode(s) is/are the first sub-target second touch electrode(s). Since the capacitance value of the first sub-target second touch electrode(s) is the largest, which means that its/their contribution to touch is higher, the first sub-target second touch electrode(s) with higher contribution to touch is/are filtered out for use in determining the target touch position coordinates later, further improving the accuracy.

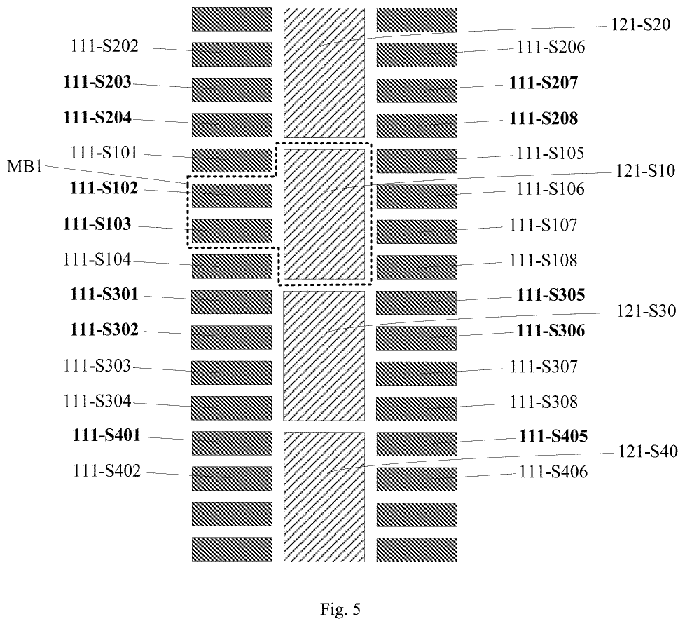

Exemplarily, as shown in FIG. 4 and FIG. 5, there are four target second touch electrodes, and the one with a capacitance value greater than the second threshold among these four target second touch electrodes can be determined as the first sub-target second touch electrode 121-S10. Those with capacitance values not greater than the second threshold among these four target second touch electrodes can be determined as the second sub-target second touch electrodes 121-S20, 121-S30, 121-S40. Here, there is one first sub-target second touch electrode 121-S10, and there are three second sub-target second touch electrodes 121-S20, 121-S30, 121-S40. There are 26 target first touch electrodes, where the target first touch electrodes adjacent to the first sub-target second touch electrode 121-S10 are 111-S101, 111-S102, 111-S103, 111-S104, 111-S105, 111-S106, 111-S107 and 111-S108, a total of 8. Among the eight target first touch electrodes 111-S101, 111-S102, 111-S103, 111-S104, 111-S105, 111-S106, 111-S107 and 111-S108 adjacent to the first sub-target second touch electrode 121-S10, those with capacitance values not greater than the second threshold are the target first touch electrodes 111-S102 and 111-S103. Therefore, the target first touch electrodes 111-S102 and 111-S103 may be determined as the first sub-target first touch electrodes.

And, among the target first touch electrodes 111-S202, 111-S203, 111-S204, 111-S206, 111-S207 and 111-S208 adjacent to the second sub-target second touch electrode 121-S20, those with capacitance values greater than the first threshold among these six target first touch electrodes are the target first touch electrodes 111-S203, 111-S204, 111-S207 and 111-S208, so the target first touch electrodes 111-S203, 111-S204, 111-S207 and 111-S208 may be taken as the second sub-target first touch electrodes corresponding to the second sub-target second touch electrode 121-S20. Similarly, the target first touch electrodes 111-S301, 111-S302, 111-S305 and 111-S306 may be taken as the second sub-target first touch electrodes corresponding to the second sub-target second touch electrode 121-S30, and the target first touch electrodes 111-S401 and 111-S405 may be taken as the second sub-target first touch electrodes corresponding to the second sub-target second touch electrode 121-S40.

In a specific implementation and in some embodiments of the disclosure, the determining the target touch position coordinates according to the capacitance value and position coordinates of the first sub-target second touch electrode, the capacitance values and position coordinates of the first sub-target first touch electrodes, the capacitance values and position coordinates of the second sub-target second touch electrodes, and the capacitance value sand position coordinates of the second sub-target first touch electrodes, may include:

dividing the first sub-target second touch electrode equally into a plurality of first split second touch electrodes and dividing the second sub-target second touch electrodes each equally into a plurality of second split second touch electrodes according to the proportional relationship between second touch electrodes and first touch electrodes in the touch screen; wherein first split second touch electrodes in the same first sub-target second touch electrode are arranged in an extension direction of the second touch electrodes, and second split second touch electrodes in the same second sub-target second touch electrode are arranged in the extension direction of the second touch electrodes;

selecting position coordinates of a first set position in a first target area formed by the first sub-target second touch electrode and the first sub-target first touch electrodes as the first initial coordinates (x01, y01);

determining the first intermediate coordinates (X01′, Y01′) by using the following first formula group according to the first initial coordinates (x01, y01); wherein (x1ᵢ, y1ᵢ) represents the i^{th} center position coordinates in the total number formed by all the first sub-target first touch electrode, all the second sub-target first touch electrodes, all the first split second touch electrodes and all the second split second touch electrodes; D1ᵢ represents the distance between the i^{th} center position coordinates and the first initial coordinates, and S1ᵢ represents the i^{th} capacitance value;

$$D {1}_{i} = \sqrt{{( x {1}_{i} - {x}_{01} )}^{2} + {( y {1}_{i} - {y}_{01} )}^{2}} ;$$

$$X {01}^{′} = \frac{{\sum }_{i = 1}^{I} \frac{S {1}_{i}}{D {1}_{i}} * x {1}_{i}}{{\sum }_{i = 1}^{I} \frac{S {1}_{i}}{D {1}_{i}}} ;$$

$$Y {01}^{′} = \frac{{\sum }_{i = 1}^{I} \frac{S {1}_{i}}{D {1}_{i}} * y {1}_{i}}{{\sum }_{i = 1}^{I} \frac{S {1}_{i}}{D {1}_{i}}} ;$$

updating the first initial coordinates (x01, y01) according to the determined first intermediate coordinates (X01′, Y01′); and determining new first intermediate coordinates (X01′, Y01′) according to the updated first initial coordinates (x01, y01) by using the first formula group again; and updating the first initial coordinates (x01, y01) according to the determined new first intermediate coordinates (X01′, Y01′) until the update times satisfy an update threshold, and taking the last updated first initial coordinates (x01, y01) as the target touch position coordinates. In this way, the accurate touch position can be approached infinitely by updating the first initial coordinates (x01, y01), further improving the accuracy.

In a specific implementation and in some embodiments of the disclosure, the position coordinates of the first set position are the center position coordinates of the first target area. As shown in FIGS. 4 and 5, the first sub-target second touch electrode 121-S10 and the first sub-target first touch electrodes 111-S102 and 111-S103 form the first target area MB1, and the first initial coordinates (X01, y01) may be the coordinates corresponding to the center position of the first target area MB1.

The above touch positioning method provided by the embodiments of the disclosure will be explained below by way of the specific embodiments.

With reference to FIGS. 4 to 6D, the touch positioning method provided by some embodiments of the disclosure may include the following steps.

S11: acquiring capacitance values and position coordinates of each first touch electrode and each second touch electrode in a touch screen. Exemplarily, the capacitance values of each first touch electrode and each second touch electrode may be detected by a driver IC, and the position coordinates of each first touch electrode are obtained by detecting the change of the capacitance value of each first touch electrode. And the position coordinates of each second touch electrode are obtained by detecting the change of the capacitance value of each second touch electrode.

S12: for each second touch electrode, judging whether the capacitance value of the second touch electrode is greater than a first threshold. Exemplarily, the first threshold may be set as 25% of the average value.

S13: determining the second touch electrode as a target second touch electrode when judging that the capacitance value of the second touch electrode is greater than the first threshold. Exemplarily, as shown in FIG. 5, there may be four target second touch electrodes, for example, 121-S10, 121-S20, 121-S30, 121-S40.

S14: among first touch electrodes adjacent to each target second touch electrode, determining a first touch electrode with a capacitance value greater than the first threshold as a target first touch electrode. Exemplarily, as shown in FIG. 5, eight first touch electrodes around the four target second touch electrodes are the adjacent first touch electrodes. Among these first touch electrodes, the first touch electrodes with capacitance values each greater than the first threshold can be determined as the target first touch electrodes, for example, 111-S101, 111-S102, 111-S103, 111-S104, 111-S105, 111-S106, 111-S107, 111-S108, 111-S202, 111-S203, 111-S204, 111-S206, 111-S207, 111-S208, 111-S301, 111-S302, 111-S303, 111-S304, 111-S305, 111-S306, 111-S307, 111-S308, 111-S401, 111-S402, 111-S405, 111-S406, a total of 26.

S15: among the target second touch electrodes, determining a target second touch electrode with a capacitance value greater than a second threshold as a first sub-target second touch electrode, and determining a target second touch electrode with a capacitance value not greater than a second threshold as a second sub-target second touch electrode. Exemplarily, the second threshold may be set as 45% of the average value. As shown in FIG. 5, the first sub-target second touch electrode is 121-S10. The second sub-target second touch electrodes are 121-S20, 121-S30, 121-S40. In addition, the capacitance value of the first sub-target second touch electrode 121-S10 is the maximum value among the capacitance values of the target second touch electrodes.

S16: among the eight target first touch electrodes 111-S101, 111-S102, 111-S103, 111-S104, 111-S105, 111-S106, 111-S107 and 111-S108 adjacent to the first sub-target second touch electrode 121-S10, those with capacitance values not greater than the second threshold are the target first touch electrodes 111-S102 and 111-S103. Therefore, the target first touch electrodes 111-S102 and 111-S103 may be determined as the first sub-target first touch electrodes.

And, among the target first touch electrodes 111-S202, 111-S203, 111-S204, 111-S206, 111-S207 and 111-S208 adjacent to the second sub-target second touch electrode 121-S20, those with capacitance values greater than the first threshold among these six target first touch electrodes are the target first touch electrodes 111-S203, 111-S204, 111-S207 and 111-S208, so the target first touch electrodes 111-S203, 111-S204, 111-S207 and 111-S208 may be taken as the second sub-target first touch electrodes corresponding to the second sub-target second touch electrode 121-S20. Similarly, the target first touch electrodes 111-S301, 111-S302, 111-S305 and 111-S306 may be taken as the second sub-target first touch electrodes corresponding to the second sub-target second touch electrode 121-S30, and the target first touch electrodes 111-S401 and 111-S405 may be taken as the second sub-target first touch electrodes corresponding to the second sub-target second touch electrode 121-S40.

S17: dividing the first sub-target second touch electrode equally into a plurality of first split second touch electrodes and dividing the second sub-target second touch electrodes each equally into a plurality of second split second touch electrodes according to the proportional relationship between second touch electrodes and first touch electrodes in the touch screen. It should be noted that the first split second touch electrodes are obtained by equal division, so the capacitance values of these first split second touch electrodes can be regarded as being obtained by dividing the capacitance value of the first sub-target second touch electrode equally. And, the second split second touch electrodes are obtained by equal division, so the capacitance values of these second split second touch electrodes can be regarded as being obtained by dividing the capacitance value of the second sub-target second touch electrode equally.

Exemplarily, as shown in FIG. 1, there are 20 second touch electrodes and 80 first touch electrodes in the touch screen. Then the proportional relationship of the second touch electrodes and the first touch electrodes in the touch screen is 1:4. Of course, it may be determined according to actual application requirements, which is not limited here.

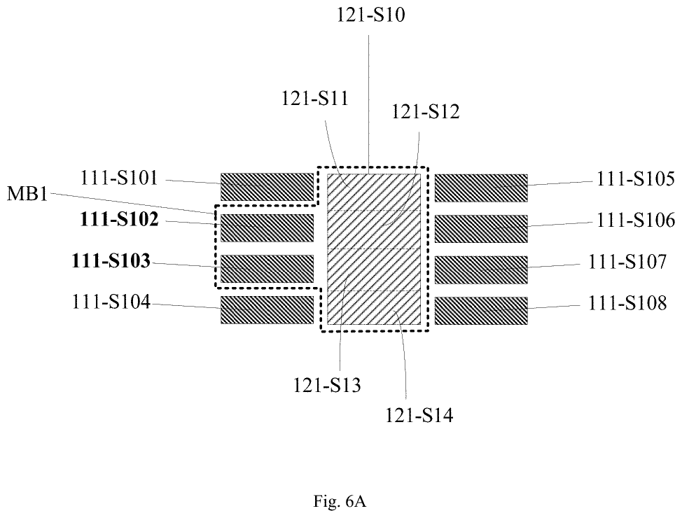

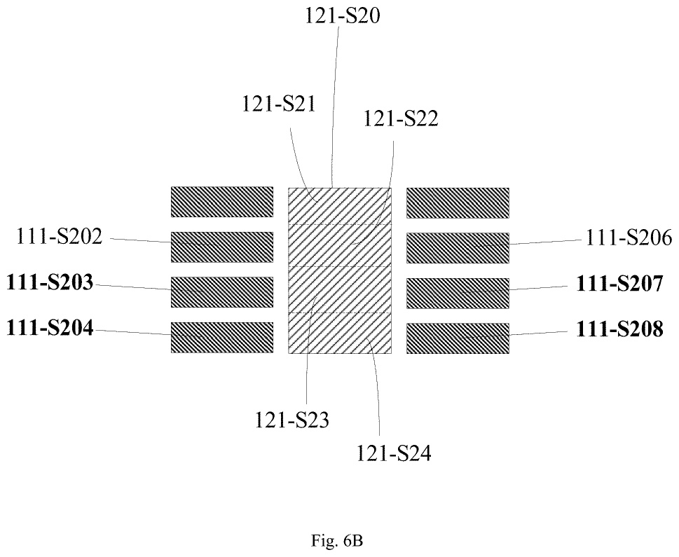

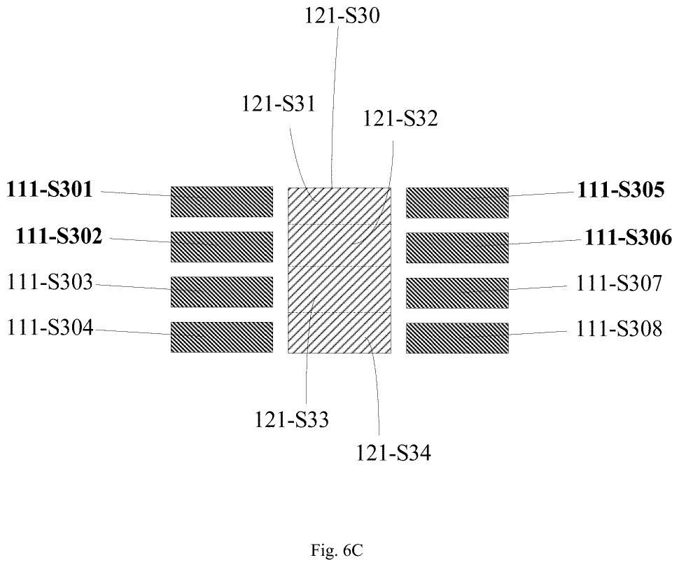

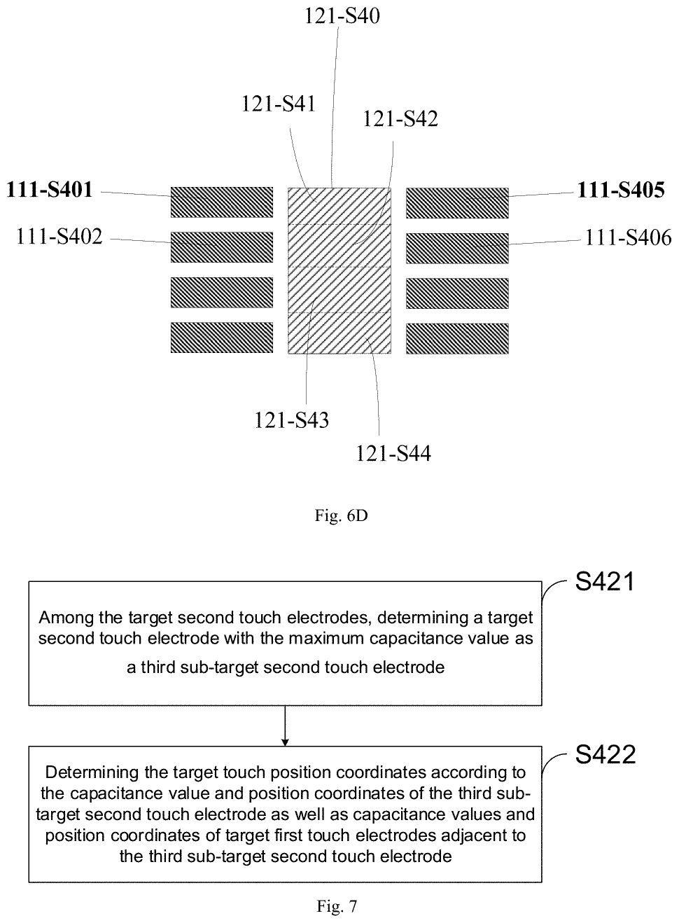

Exemplarily, as shown in FIGS. 5 and 6A, the first sub-target second touch electrode 121-S10 may be equally divided into four first split second touch electrodes: 121-S11, 121-S12, 121-S13, 121-S14. The first split second touch electrodes 121-S11, 121-S12, 121-S13, 121-S14 in the same first sub-target second touch electrode are arranged in the extension direction of the second touch electrodes. And, the capacitance values of the first split second touch electrodes 121-S11, 121-S12, 121-S13, 121-S14 may all be V_{121-S10}/4, here V_{121-S10} represents the capacitance value of the first sub-target second touch electrode 121-S10.

Exemplarily, as shown in FIGS. 5 and 6B, the second sub-target second touch electrode 121-S20 may be equally divided into four second split second touch electrodes: 121-S21, 121-S22, 121-S23, 121-S24. The second split second touch electrodes 121-S21, 121-S22, 121-S23, 121-S24 in the same second sub-target second touch electrode are arranged in the extension direction of the second touch electrodes. And, the capacitance values of the second split second touch electrodes 121-S21, 121-S22, 121-S23, 121-S24 may all be V_{121-S20}/4, here V_{121-S20} represents the capacitance value of the second sub-target second touch electrode 121-S20.

Exemplarily, as shown in FIGS. 5 and 6C, the second sub-target second touch electrodes 121-S30 may be equally divided into four second split second touch electrodes: 121-S31, 121-S32, 121-S33, 121-S34. The second split second touch electrodes 121-S31, 121-S32, 121-S33, 121-S34 in the same second sub-target second touch electrode are arranged in the extension direction of the second touch electrodes. And, the capacitance values of the second split second touch electrodes 121-S31, 121-S32, 121-S33, 121-S34 may all be V_{121-S30}/4, here V_{121-S30} represents the capacitance value of the second sub-target second touch electrode 121-S30.

Exemplarily, as shown in FIGS. 5 and 6D, the second sub-target second touch electrodes 121-S40 may be equally divided into four second split second touch electrodes: 121-S41, 121-S42, 121-S43, 121-S44. The second split second touch electrodes 121-S41, 121-S42, 121-S43, 121-S44 in the same second sub-target second touch electrode are arranged in the extension direction of the second touch electrodes. And, the capacitance values of the second split second touch electrodes 121-S41, 121-S42, 121-S43, 121-S44 may all be V_{121-S40}/4, here V_{121-S40} represents the capacitance value of the second sub-target second touch electrode 121-S40.

S18: as shown in FIGS. 5 and 6a, selecting the coordinates corresponding to the center position of the first target area MB1 formed by the first sub-target second touch electrode 121-S10 and the first sub-target first touch electrodes (i.e., 111-S102 and 111-S103) as the first initial coordinates (x01, y01).

S19: as shown in FIGS. 5 to 6D, the total number of all the first sub-target first touch electrodes and all the second sub-target first touch electrodes is 12, and the total number of all the first split second touch electrodes and all the second split second touch electrodes is 16, so the total number of all the first sub-target first touch electrodes, all the second sub-target first touch electrodes, all the first split second touch electrodes and all the second split second touch electrodes is 28, that is, I=28. Then, (x1ᵢ, y1ᵢ) represents the center position coordinates of the i^{th} electrode in the total number of 28 formed by all the first sub-target first touch electrodes, all the second sub-target first touch electrodes, all the first split second touch electrodes and all the second split second touch electrodes.

For example, taking the first split second touch electrode 121-S11 as the 1^{st} one in the total number of 28, then (x1₁, y1₁) represents the center position coordinates of the 1^{st} one electrode in the total number of 28.

Taking the target first touch electrode 111-S204 determined as the second sub-target first touch electrode as the 2^{nd} one in the total number of 28, then (x1₂, y1₂) represents the center position coordinates of the 2^{nd} one in the total number of 28.

Taking the target first touch electrode 111-S207 determined as the second sub-target first touch electrode as the 3^{rd} one in the total number of 28, then (x1₃, y1₃) represents the center position coordinates of the 3^{rd} one in the total number of 28.

Taking the target first touch electrode 111-S208 determined as the second sub-target first touch electrode as the 4^{th} one in the total number of 28, then (x1₄, y1₄) represents the center position coordinates of the 4^{th} one in the total number of 28.

Taking the target first touch electrode 111-S102 determined as the first sub-target first touch electrode as the 5^{th} one in the total number of 28, then (x1₅, y1₅) represents the center position coordinates of the 5^{th} one in the total number of 28.

Taking the target first touch electrode 111-S103 determined as the first sub-target first touch electrode as the 6^{th} one in the total number of 28, then (x1₆, y1₆) represents the center position coordinates of the 6^{th} one in the total number of 28.

Taking the target first touch electrode 111-S301 determined as the second sub-target first touch electrode as the 7^{th} one in the total number of 28, then (x1₇, y1₇) represents the center position coordinates of the 7^{th} one in the total number of 28.

Taking the target first touch electrode 111-S302 determined as the second sub-target first touch electrode as the 8^{th} one in the total number of 28, then (x1₈, y1₈) represents the center position coordinates of the 8^{th} one in the total number of 28.

Taking the target first touch electrode 111-S305 determined as the second sub-target first touch electrode as the 9^{th} one in the total number of 28, then (x1₉, y1₉) represents the center position coordinates of the 9^{th} one in the total number of 28.

Taking the target first touch electrode 111-S306 determined as the second sub-target first touch electrode as the 10^{th} one in the total number of 28, then (x1₁₀, y1₁₀) represents the center position coordinates of the 10^{th} one in the total number of 28.

Taking the target first touch electrode 111-S401 determined as the second sub-target first touch electrode as the 11^{th} one in the total number of 28, then (x1₁₁, y1₁₁) represents the center position coordinates of the 11^{th} one in the total number of 28.

Taking the target first touch electrode 111-S405 determined as the second sub-target first touch electrode as the 12^{th} one in the total number of 28, then (x1₁₂, y1₁₂) represents the center position coordinates of the 12^{th} one in the total number of 28.

Taking the target first touch electrode 111-S203 determined as the second sub-target first touch electrode as the 13^{th} one in the total number of 28, then (x1₁₃, y1₁₃) represents the center position coordinates of the 13^{th} one in the total number of 28.

Taking the first split second touch electrode 121-S12 as the 14^{th} one in the total number of 28, then (x1₁₄, y1₁₄) represents the center position coordinates of the 14^{th} one in the total number of 28.

Taking the first split second touch electrode 121-S13 as the 15^{th} one in the total number of 28, then (x1₁₅, y1₁₅) represents the center position coordinates of the 15^{th} one in the total number of 28.

Taking the first split second touch electrode 121-S14 as the 16^{th} one in the total number of 28, then (x1₁₆, y1₁₆) represents the center position coordinates of the 16^{th} one in the total number of 28.

Taking the second split second touch electrode 121-S21 as the 17^{th} one in the total number of 28, then (x1₁₇, y1₁₇) represents the center position coordinates of the 17^{th} one in the total number of 28.

Taking the second split second touch electrode 121-S22 as the 18^{th} one in the total number of 28, then (x1₁₈, y1₁₈) represents the center position coordinates of the 18^{th} one in the total number of 28.

Taking the second split second touch electrode 121-S23 as the 19^{th} one in the total number of 28, then (x1₁₉, y1₁₉) represents the center position coordinates of the 19^{th} one in the total number of 28.

Taking the second split second touch electrode 121-S24 as the 20^{th} one in the total number of 28, then (x1₂₀, y1₂₀) represents the center position coordinates of the 20^{th} one in the total number of 28.

Taking the second split second touch electrode 121-S31 as the 21^{th} one in the total number of 28, then (x1₂₁, y1₂₁) represents the center position coordinates of the 21^{th} one in the total number of 28.

Taking the second split second touch electrode 121-S32 as the 22^{th} one in the total number of 28, then (x1₂₂, y1₂₂) represents the center position coordinates of the 22^{th} one in the total number of 28.

Taking the second split second touch electrode 121-S33 as the 23^{th} one in the total number of 28, then (x1₂₃, y1₂₃) represents the center position coordinates of the 23^{th} one in the total number of 28.

Taking the second split second touch electrode 121-S34 as the 24^{th} one in the total number of 28, then (x1₂₄, y1₂₄) represents the center position coordinates of the 24^{th} one in the total number of 28.

Taking the second split second touch electrode 121-S41 as the 25^{th} one in the total number of 28, then (x1₂₅, y1₂₅) represents the center position coordinates of the 25^{th} one in the total number of 28.

Taking the second split second touch electrode 121-S42 as the 26^{th} one in the total number of 28, then (x1₂₆, y1₂₆) represents the center position coordinates of the 26^{th} one in the total number of 28.

Taking the second split second touch electrode 121-S43 as the 27^{th} one in the total number of 28, then (x1₂₇, y1₂₇) represents the center position coordinates of the 27^{th} one in the total number of 28.

Taking the second split second touch electrode 121-S44 as the 28^{th} one in the total number of 28, then (x1₂₈, y1₂₈) represents the center position coordinates of the 28^{th} one in the total number of 28.

According to the first initial coordinates (x01, y01) and (x1₁, y1₁), the first intermediate coordinates (X01′, Y01′) are determined by using the following first formula group:

$$D {1}_{1} = \sqrt{{( x {1}_{1} - {x}_{01} )}^{2} + {( y {1}_{1} - {y}_{01} )}^{2}} ;$$

$$X {01}^{′} = \frac{\frac{S {1}_{1}}{D {1}_{1}} * x {1}_{1}}{\frac{S {1}_{1}}{D {1}_{1}}} ;$$

$$Y {01}^{′} = \frac{\frac{S {1}_{1}}{D {1}_{1}} * y {1}_{1}}{\frac{S {1}_{1}}{D {1}_{1}}} .$$

S20: performing the first update of the first initial coordinates (x01, y01) in step S18 according to the first intermediate coordinates (X01′, Y01′) determined in step S19 to obtain the first initial coordinates (x01, y01) after the first update.

S21: determining new first intermediate coordinates (X01′, Y01′) by using the following first formula group according to the first initial coordinates (x01, y01) after the first update in step S20 and (x12, y12); here D1₁ is D1₁ in step S19.

$$D {1}_{2} = \sqrt{{( x {1}_{2} - {x}_{01} )}^{2} + {( y {1}_{2} - {y}_{01} )}^{2}} ;$$

$$X {01}^{′} = \frac{\frac{S {1}_{1}}{D {1}_{1}} * x {1}_{1} + \frac{S {1}_{2}}{D {1}_{2}} * x {1}_{2}}{\frac{S {1}_{1}}{D {1}_{1}} + \frac{S {1}_{2}}{D {1}_{2}}} ;$$

$$Y {01}^{′} = \frac{\frac{S {1}_{1}}{D {1}_{1}} * y {1}_{1} + \frac{S {1}_{2}}{D {1}_{2}} * y {1}_{2}}{\frac{S {1}_{1}}{D {1}_{1}} + \frac{S {1}_{2}}{D {1}_{2}}} .$$

S22: performing the second update of the first initial coordinates (x01, y01) determined in step S20 according to the new first intermediate coordinates (X01′, Y01′) determined in step S21 to obtain the first initial coordinates (x01, y01) after the second update.

S23: determining new first intermediate coordinates (X01′, Y01′) by using the following first formula group according to the first initial coordinates (x01, y01) after the second update in step S22 and (x1₃, y1₃); here D1₂ is D1₂ in step S21.

$$D {1}_{3} = \sqrt{{( x {1}_{3} - {x}_{01} )}^{2} + {( y {1}_{3} - {y}_{01} )}^{2}} ;$$

$$X {01}^{′} = \frac{\frac{S {1}_{1}}{D {1}_{1}} * x {1}_{1} + \frac{S {1}_{2}}{D {1}_{2}} * x {1}_{2} + \frac{S {1}_{3}}{D {1}_{3}} * x {1}_{3}}{\frac{S {1}_{1}}{D {1}_{1}} + \frac{S {1}_{2}}{D {1}_{2}} + \frac{S {1}_{3}}{D {1}_{3}}} ;$$

$$Y {01}^{′} = \frac{\frac{S {1}_{1}}{D {1}_{1}} * y {1}_{1} + \frac{S {1}_{2}}{D {1}_{2}} * y {1}_{2} + \frac{S {1}_{3}}{D {1}_{3}} * y {1}_{3}}{\frac{S {1}_{1}}{D {1}_{1}} + \frac{S {1}_{2}}{D {1}_{2}} + \frac{S {1}_{3}}{D {1}_{3}}} .$$

S24: performing the third update of the first initial coordinates (x01, y01) determined in step S22 according to the new first intermediate coordinates (X01′, Y01′) determined in step S23 to obtain the first initial coordinates (x01, y01) after the third update.

Then, According to at least one of (x1₄, y1₄) to (x1₂₈, y1₂₈), the first initial coordinates (x01, y01) are updated again according to the process similar to that in step S21 to step S24. The number of (x1₄, y1₄) to (x1₂₈, y1₂₈) may be determined according to the update threshold. For example, if the update threshold is set as 10, the first initial coordinates (x01, y01) updated according to (x1₄, y1₄) to (x1₁₀, y1₁₀) can be determined as the target touch position coordinates. Alternatively, if the update threshold is set as 15, the first initial coordinates (x01, y01) updated according to (x1₄, y1₄) to (x1₁₅, y1₁₅) can be determined as the target touch position coordinates. Of course, in practical applications, the specific value of the update threshold may be set based on experience, or may also be set based on the actual application requirements, which is not limited here.

Some embodiments of the disclosure further provide a touch positioning method, as shown in FIG. 7, which are modified from the implementations in the above embodiments. Only the differences between these embodiments and the above embodiments are illustrated below, and the similarities thereof are not repeated here.

In a specific implementation and in some embodiments of the disclosure, as shown in FIG. 7, the determining the target touch position coordinates according to the capacitance values and position coordinates of the target second touch electrodes as well as the capacitance values and position coordinates of the target first touch electrodes, may specifically include the following steps.

S421: among the target second touch electrodes, determining a target second touch electrode with the maximum capacitance value as a third sub-target second touch electrode.

S422: determining the target touch position coordinates according to the capacitance value and position coordinates of the third sub-target second touch electrode as well as the capacitance values and position coordinates of target first touch electrodes adjacent to the third sub-target second touch electrode.

Since the target second touch electrode with the maximum capacitance value (that is, the third sub-target second touch electrode) contributes the most to the touch, the target touch position coordinates can be determined through only the capacitance value and position coordinates of the third sub-target second touch electrode as well as the capacitance values and position coordinates of target first touch electrodes adjacent to the third sub-target second touch electrode, thereby further reducing the amount of calculations and reducing the power consumption.

In a specific implementation and in some embodiments of the disclosure, the determining the target touch position coordinates according to the capacitance value and position coordinates of the third sub-target second touch electrode as well as the capacitance values and position coordinates of target first touch electrodes adjacent to the third sub-target second touch electrode, may include:

among the target first touch electrodes adjacent to the third sub-target second touch electrode, determining a target first touch electrode with a capacitance value greater than the first threshold and less than a second threshold as a third sub-target first touch electrode; and

determining the target touch position coordinates according to the capacitance value and position coordinates of the third sub-target second touch electrode as well as the capacitance value and position coordinates of the third sub-target first touch electrode.

In a specific implementation and in some embodiments of the disclosure, the determining the target touch position coordinates according to the capacitance value and position coordinates of the third sub-target second touch electrode as well as the capacitance value and position coordinates of the third sub-target first touch electrode, includes:

dividing the third sub-target second touch electrode equally into a plurality of third split second touch electrodes according to the proportional relationship between second touch electrodes and first touch electrodes in the touch screen; here third split second touch electrodes in the same third sub-target second touch electrode are arranged in the extension direction of the second touch electrodes;

selecting position coordinates of a second set position in a second target area formed by the third sub-target second touch electrode and the third sub-target first touch electrode as second initial coordinates (x02, y02);

determining second intermediate coordinates (X02′, Y02′) by using the following second formula group according to the second initial coordinates (x02, y02); here (x1ₙ, y1ₙ) represents the n^{th} center position coordinates in the total number formed by all the third sub-target first touch electrode(s) and all the third split second touch electrodes, D1ₙ represents the distance between the n^{th} center position coordinates and the second initial coordinates, and S1ₙ represents the n^{th} capacitance value;

$$D {1}_{n} = \sqrt{{( x {1}_{n} - {x}_{02} )}^{2} + {( y {1}_{n} - {y}_{02} )}^{2}} ;$$

$$X {02}^{′} = \frac{{\sum }_{n = 1}^{N} \frac{S {1}_{n}}{D {1}_{n}} * x {1}_{n}}{{\sum }_{n = 1}^{N} \frac{S {1}_{n}}{D {1}_{n}}} ;$$

$$Y {02}^{′} = \frac{{\sum }_{n = 1}^{N} \frac{S {1}_{n}}{D {1}_{n}} * y {1}_{n}}{{\sum }_{n = 1}^{N} \frac{S {1}_{n}}{D {1}_{n}}} .$$

updating the second initial coordinates (x02, y02) according to the determined second intermediate coordinates (X02′, Y02′); and determining new second intermediate coordinates (X02′, Y02′) according to the updated second initial coordinates (x02, y02) by using the second formula group; and updating the second initial coordinates (x02, y02) according to the determined new second intermediate coordinates (X02′, Y02′) until the update times satisfy an update threshold, and taking the last updated second initial coordinates (x02, y02) as the target touch position coordinates. In this way, the accurate touch position can be approached infinitely by updating the second initial coordinates (x02, y02), further improving the accuracy.

In a specific implementation and in some embodiments of the disclosure, the position coordinates of the second set position are the center position coordinates of the second target area. As shown in FIGS. 4, 8 and 9, the third sub-target second touch electrode 121-S50 and the third sub-target first touch electrodes 111-S502 and 111-S503 form the second target area MB2, and the second initial coordinates (X02, y02) may be the coordinates corresponding to the center position of the second target area MB2.

The above touch positioning method provided by embodiments of the disclosure will be explained below by way of the specific embodiments.

With reference to FIGS. 4, 8 and 9, the touch positioning method provided by some embodiments of the disclosure may include the following steps.

S11: acquiring the capacitance values and position coordinates of each first touch electrode and each second touch electrode in a touch screen. Exemplarily, the capacitance values of each first touch electrode and each second touch electrode may be detected by a driver IC, and the position coordinates of each first touch electrode are obtained by detecting the change of the capacitance value of each first touch electrode. And the position coordinates of each second touch electrode are obtained by detecting the change of the capacitance value of each second touch electrode.

S12: for each second touch electrode, judging whether the capacitance value of the second touch electrode is greater than a first threshold. Exemplarily, the first threshold may be set as 25% of the average value.

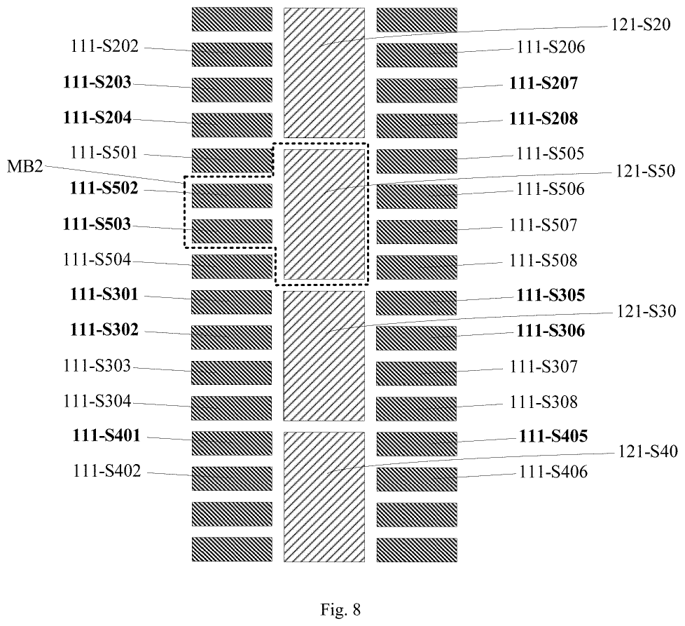

S13: determining the second touch electrode as a target second touch electrode when judging that the capacitance value of the second touch electrode is greater than the first threshold. Exemplarily, as shown in FIG. 8, there may be four target second touch electrodes, for example, 121-S50, 121-S20, 121-S30, 121-S40.

S14: among the first touch electrodes adjacent to the target second touch electrodes, determining a first touch electrode with a capacitance value greater than the first threshold as a target first touch electrode. Exemplarily, as shown in FIG. 5, eight first touch electrodes around the four target second touch electrodes are the adjacent first touch electrodes. Among these first touch electrodes, the first touch electrodes with capacitance values greater than the first threshold can be determined as the target first touch electrodes, for example, 111-S501, 111-S502, 111-S503, 111-S504, 111-S505, 111-S506, 111-S507, 111-S508, 111-S202, 111-S203, 111-S204, 111-S206, 111-S207, 111-S208, 111-S301, 111-S302, 111-S303, 111-S304, 111-S305, 111-S306, 111-S307, 111-S308, 111-S401, 111-S402, 111-S405, 111-S406, a total of 26.

S15: among the target second touch electrodes, determining a target second touch electrode with the maximum capacitance value as a third sub-target second touch electrode. Exemplarily, as shown in FIG. 5, the third sub-target second touch electrode is 121-S50.

S16: among eight target first touch electrodes 111-S501, 111-S502, 111-S503, 111-S504, 111-S505, 111-S506, 111-S507 and 111-S508 adjacent to the third sub-target second touch electrode 121-S50, those with capacitance values greater than the first threshold and less than the second threshold are the target first touch electrodes 111-S502 and 111-S503. Therefore, the target first touch electrodes 111-S502 and 111-S503 may be determined as the third sub-target first touch electrodes.

S17: dividing the third sub-target second touch electrode equally into a plurality of third split second touch electrodes according to the proportional relationship between second touch electrodes and first touch electrodes in the touch screen.

Exemplarily, as shown in FIG. 1, there are 20 second touch electrodes and 80 first touch electrodes in the touch screen. Then the proportional relationship of the second touch electrodes and the first touch electrodes in the touch screen is 1:4. Of course, it may be determined according to actual application requirements, which is not limited here.

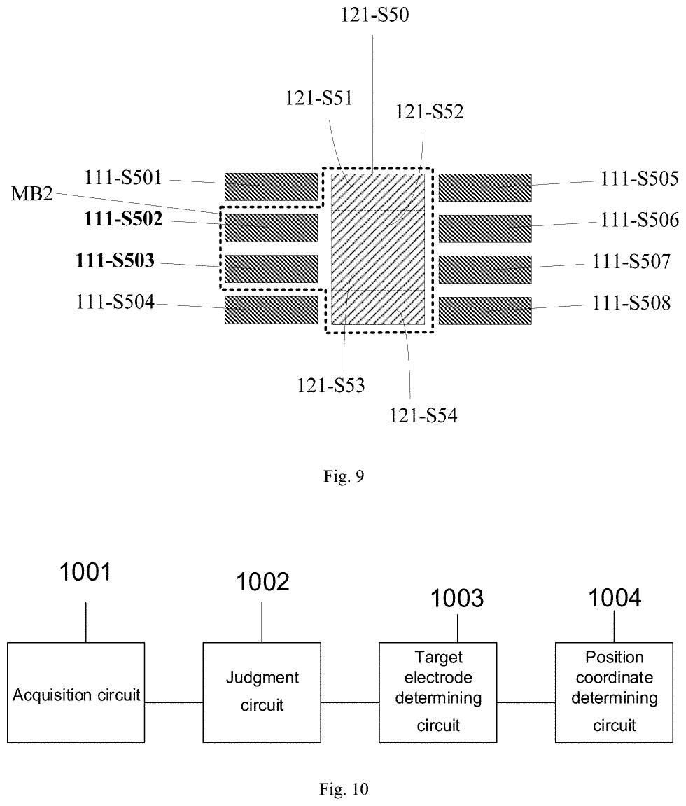

Exemplarily, as shown in FIGS. 8 and 9, the third sub-target second touch electrodes 121-S50 may be equally divided into four third split second touch electrodes: 121-S51, 121-S52, 121-S53, 121-S54. The third split second touch electrodes 121-S51, 121-S52, 121-S53, 121-S54 in the same third sub-target second touch electrode are arranged in the extension direction of the second touch electrodes. And, the capacitance values of the third split second touch electrodes 121-S51, 121-S52, 121-S53, 121-S54 may all be V_{121-S50}/4, here V_{121-S50} represents the capacitance values of the third sub-target second touch electrode 121-S50.

S18: as shown in FIGS. 4, 8 and 9, selecting the coordinates corresponding to the center position of the second target area MB2 formed by the third sub-target second touch electrodes 121-S50 as well as the target first touch electrodes 111-S502 and 111-S503 (as the third sub-target first touch electrodes) as the second initial coordinates (x02, y02).

S19: as shown in FIGS. 4, 8 and 9, the total number of all the third sub-target first touch electrodes and all the third split second touch electrodes is 6, that is, N=6. Then, (x1ₙ, y1ₙ) represents the center position coordinates of the n^{th} electrode in the total number of 6 formed by all the third sub-target first touch electrodes and all the third split second touch electrodes.

For example, taking the third split second touch electrode 121-S51 as the 1^{st} one in the total number of 6, then (x1₁, y1₁) represents the center position coordinates of the 1^{st} one in the total number of 6.

Taking the third split second touch electrode 121-S52 as the 2nd one in the total number of 6, then (x1₂, y1₂) represents the center position coordinates of the 2^{nd} one in the total number of 6.

Taking the third split second touch electrode 121-S53 as the 3^{rd} one in the total number of 6, then (x1₃, y1₃) represents the center position coordinates of the 3^{rd} one in the total number of 6.

Taking the third split second touch electrode 121-S54 as the 4^{th} one in the total number of 6, then (x1₄, y1₄) represents the center position coordinates of the 4^{th} one in the total number of 6.

Taking the target first touch electrode 111-S502 determined as the third sub-target first touch electrode as the 5^{th} one in the total number of 6, then (x1₅, y1₅) represents the center position coordinates of the 5^{th} one in the total number of 6.

Taking the target first touch electrode 111-S503 determined as the third sub-target first touch electrode as the 6^{th} one in the total number of 6, then (x1₆, y1₆) represents the center position coordinates of the 6^{th} one in the total number of 6.

According to the second initial coordinates (x02, y02) and (x1₁, y1₁), the second intermediate coordinates (X02′, Y02′) are determined by using the following second formula group:

$$D {1}_{1} = \sqrt{{( x {1}_{1} - {x}_{02} )}^{2} + {( y {1}_{1} - {y}_{02} )}^{2}} ;$$

$$X {01}^{′} = \frac{\frac{S {1}_{1}}{D {1}_{1}} * x {1}_{1}}{\frac{S {1}_{1}}{D {1}_{1}}} ;$$

$$Y {01}^{′} = \frac{\frac{S {1}_{1}}{D {1}_{1}} * y {1}_{1}}{\frac{S {1}_{1}}{D {1}_{1}}} .$$

S20: performing the first update of the second initial coordinates (x02, y02) in step S18 according to the second intermediate coordinates (X02′, Y02′) determined in step S19 to obtain the second initial coordinates (x02, y02) after the first update.

S21: determining new second intermediate coordinates (X02′, Y02′) by using the following second formula group according to the second initial coordinates (x02, y02) after the first update in step S20 and (x1₂, y1₂); here D1₁ is D1₁ in step S19.

$$D {1}_{2} = \sqrt{{( x {1}_{2} - {x}_{01} )}^{2} + {( y {1}_{2} - {y}_{01} )}^{2}} ;$$

$$X {01}^{′} = \frac{\frac{S {1}_{1}}{D {1}_{1}} * x {1}_{1} + \frac{S {1}_{2}}{D {1}_{2}} * x {1}_{2}}{\frac{S {1}_{1}}{D {1}_{1}} + \frac{S {1}_{2}}{D {1}_{2}}} ;$$

$$Y {01}^{′} = \frac{\frac{S {1}_{1}}{D {1}_{1}} * y {1}_{1} + \frac{S {1}_{2}}{D {1}_{2}} * y {1}_{2}}{\frac{S {1}_{1}}{D {1}_{1}} + \frac{S {1}_{2}}{D {1}_{2}}} .$$

S22: performing the second update of the second initial coordinates (x02, y02) determined in step S20 according to the second intermediate coordinates (X02′, Y02′) determined in step S21 to obtain the second initial coordinates (x02, y02) after the second update.

S23: determining new second intermediate coordinates (X02′, Y02′) by using the following second formula group according to the second initial coordinates (x02, y02) after the second update in step S22 and (x13, y13); here D1₂ is D1₂ in step S21.

$$D {1}_{3} = \sqrt{{( x {1}_{3} - {x}_{01} )}^{2} + {( y {1}_{3} - {y}_{01} )}^{2}} ;$$

$$X {01}^{′} = \frac{\frac{S {1}_{1}}{D {1}_{1}} * x {1}_{1} + \frac{S {1}_{2}}{D {1}_{2}} * x {1}_{2} + \frac{S {1}_{3}}{D {1}_{3}} * x {1}_{3}}{\frac{S {1}_{1}}{D {1}_{1}} + \frac{S {1}_{2}}{D {1}_{2}} + \frac{S {1}_{3}}{D {1}_{3}}} ;$$

$$Y {01}^{′} = \frac{\frac{S {1}_{1}}{D {1}_{1}} * y {1}_{1} + \frac{S {1}_{2}}{D {1}_{2}} * y {1}_{2} + \frac{S {1}_{3}}{D {1}_{3}} * y {1}_{3}}{\frac{S {1}_{1}}{D {1}_{1}} + \frac{S {1}_{2}}{D {1}_{2}} + \frac{S {1}_{3}}{D {1}_{3}}} .$$

S24: performing the third update of the second initial coordinates (x02, y02) determined in step S22 according to the second intermediate coordinates (X02′, Y02′) determined in step S23 to obtain the second initial coordinates (x02, y02) after the third update.

Then, According to at least one of (x1₄, y1₄) to (x1₆, y1₆), the second initial coordinates (x02, y02) are updated again according to the process similar to that in step S21 to step S24. The number of (x1₄, y1₄) to (x1₆, y1₆) may be determined according to the update threshold. For example, if the update threshold is set as 5, the second initial coordinates (x02, y02) updated according to (x1₄, y1₄) to (x1₅, y1₅) can be determined as the target touch position coordinates. Alternatively, if the update threshold is set as 6, the second initial coordinates (x02, y02) updated according to (x1₄, y1₄) to (x1₆, y1₆) can be determined as the target touch position coordinates. Of course, in practical applications, the specific value of the update threshold may be set based on experience, or may also be set based on the actual application requirements, which is not limited here.

Based on the same inventive concept, embodiments of the disclosure further provide a touch positioning apparatus, as shown in FIG. 10, which may include:

an acquisition circuit 1001 configured to acquire capacitance values and position coordinates of each first touch electrode and each second touch electrode in a touch screen;

a judgment circuit 1002 configured to, for each second touch electrode, judge whether the capacitance value of the second touch electrode is greater than a first threshold;

a target electrode determining circuit 1003 configured to determine the second touch electrode as a target second touch electrode when judging that the capacitance value of the second touch electrode is greater than the first threshold;

a position coordinate determining circuit 1004 configured to determine target touch position coordinates according to the capacitance value and position coordinates of the target second touch electrode as well as the capacitance value(s) and position coordinates of first touch electrode(s) adjacent to the target second touch electrode.

It should be noted that any one of the above acquisition circuit, judgment circuit, target electrode determining circuit and position coordinate determining circuit may take the form of hardware embodiments alone, software embodiments alone, or embodiments combining the software and hardware aspects. Of course, in practical applications, it may be designed according to specific requirements, which is not limited here.

It should be noted that the working principle and specific implementations of the above touch positioning apparatus are the same as those of the touch positioning method in the above embodiments. Therefore, the driving method of the touch positioning apparatus can be implemented with reference to the specific implementations of the touch positioning method in the above embodiments, and will not be repeated here.

Based on the same inventive concept, embodiments of the disclosure further provide a computer device, including a memory, a processor and a computer program that is stored on the memory and can run on the processor. The processor implements the steps of the above touch positioning method when executing the computer program.

Based on the same inventive concept, embodiments of the disclosure further provide a computer readable storage medium storing a computer program thereon, and the computer program, when executed by a processor, implements the steps of the above touch positioning method provided by the embodiments of the disclosure. Exemplarily, the disclosure may take the form of computer program products implemented on one or more computer readable storage mediums containing computer readable program codes therein.

It should be understood by those skilled in the art that the embodiments of the disclosure can be provided as methods, systems and computer program products. Thus the disclosure can take the form of hardware embodiments alone, software embodiments alone, or embodiments combining the software and hardware aspects. Also the disclosure can take the form of computer program products implemented on one or more computer readable storage mediums (including but not limited to magnetic disk memories, CD-ROMs, optical memories and the like) containing computer readable program codes therein. The computer readable storage medium includes volatile, non-volatile, removable and unremovable media implemented in any method or technique for storing the information (such as computer readable instructions, data structures, program modules, or other data). The computer storage medium includes but not limited to RAM, ROM, EENROM, flash or other memory technology, CD-ROM, Digital Versatile Disc (DVD) or other optical disc storage, magnetic box, magnetic tape, magnetic disk storage or other magnetic storage device, or any other medium which can be used to store the desired information and can be accessed by a computer.

It should be understood by those skilled in the art that the embodiments of the disclosure can be provided as methods, systems and computer program products. Thus the disclosure can take the form of hardware embodiments alone, software embodiments alone, or embodiments combining the software and hardware aspects. Also the disclosure can take the form of computer program products implemented on one or more computer usable storage mediums (including but not limited to magnetic disk memories, CD-ROMs, optical memories and the like) containing computer usable program codes therein.

The disclosure is described by reference to the flow charts and/or the block diagrams of the methods, the devices (systems) and the computer program products according to the embodiments of the disclosure. It should be understood that each process and/or block in the flow charts and/or the block diagrams, and a combination of processes and/or blocks in the flow charts and/or the block diagrams can be implemented by the computer program instructions. These computer program instructions can be provided to a general-purpose computer, a dedicated computer, an embedded processor, or a processor of another programmable data processing device to produce a machine, so that an apparatus for implementing the functions specified in one or more processes of the flow charts and/or one or more blocks of the block diagrams is produced by the instructions executed by the computer or the processor of another programmable data processing device.

These computer program instructions can also be stored in a computer readable memory which is capable of guiding the computer or another programmable data processing device to operate in a particular way, so that the instructions stored in the computer readable memory produce a manufacture including the instruction apparatus which implements the functions specified in one or more processes of the flow charts and/or one or more blocks of the block diagrams.

Of course, these computer program instructions can also be loaded onto the computer or another programmable data processing device, so that a series of operation steps are performed on the computer or another programmable device to produce the computer-implemented processing. Thus the instructions executed on the computer or another programmable device provide steps for implementing the functions specified in one or more processes of the flow charts and/or one or more blocks of the block diagrams.

Although the preferred embodiments of the disclosure have been described, those skilled in the art can make additional alterations and modifications to these embodiments once they learn about the basic creative concepts. Thus the attached claims are intended to be interpreted to include the preferred embodiments as well as all the alterations and modifications falling within the scope of the disclosure.

Evidently those skilled in the art can make various modifications and variations to the embodiments of the disclosure without departing from the spirit and scope of the embodiments of the disclosure. Thus the disclosure is also intended to encompass these modifications and variations to the embodiments of the disclosure as long as these modifications and variations come into the scope of the claims of the disclosure and their equivalents.

1. A touch positioning method, comprising:
acquiring capacitance values and position coordinates of each first touch electrode and each second touch electrode in a touch screen;
for the each second touch electrode, judging whether a capacitance value of the second touch electrode is greater than a first threshold;
determining second touch electrodes as target second touch electrodes when judging that capacitance values of the second touch electrodes each is greater than the first threshold; and
determining target touch position coordinates according to the capacitance values and position coordinates of the target second touch electrodes as well as capacitance values and position coordinates of first touch electrodes adjacent to the target second touch electrodes.

2. The touch positioning method of claim 1, wherein said determining target touch position coordinates according to the capacitance values and position coordinates of the target second touch electrodes as well as capacitance values and position coordinates of the first touch electrodes adjacent to the target second touch electrodes, comprises:
among the first touch electrodes adjacent to the target second touch electrodes, determining first touch electrodes with capacitance values each greater than the first threshold as target first touch electrodes; and
determining the target touch position coordinates according to the capacitance values and position coordinates of the target second touch electrodes as well as capacitance values and position coordinates of the target first touch electrodes.

3. The touch positioning method of claim 2, wherein said determining the target touch position coordinates according to the capacitance values and position coordinates of the target second touch electrodes as well as the capacitance values and position coordinates of the target first touch electrodes, comprises:
among the target second touch electrodes, determining a target second touch electrode with a capacitance value greater than a second threshold as a first sub-target second touch electrode, and determining a target second touch electrode with a capacitance value not greater than the second threshold as a second sub-target second touch electrode; wherein the second threshold is greater than the first threshold;
among target first touch electrodes adjacent to the first sub-target second touch electrode, determining a target first touch electrode with a capacitance value not greater than the second threshold as a first sub-target first touch electrode; and among target first touch electrodes adjacent to the second sub-target second touch electrode, determining a target first touch electrode with a capacitance value greater than the first threshold as a second sub-target first touch electrode; and
determining the target touch position coordinates according to the capacitance value and position coordinates of the first sub-target second touch electrode, the capacitance value and position coordinates of the first sub-target first touch electrode, the capacitance value and position coordinates of the second sub-target second touch electrode, and the capacitance value and position coordinates of the second sub-target first touch electrode.

4. The touch positioning method of claim 3, wherein the capacitance value of the first sub-target second touch electrode is a maximum value among capacitance values of the target second touch electrodes; and
said determining the target touch position coordinates according to the capacitance value and position coordinates of the first sub-target second touch electrode, the capacitance value and position coordinates of the first sub-target first touch electrode, the capacitance value and position coordinates of the second sub-target second touch electrode, and the capacitance value and position coordinates of the second sub-target first touch electrode, comprises:
dividing the first sub-target second touch electrode equally into a plurality of first split second touch electrodes and dividing the second sub-target second touch electrode equally into a plurality of second split second touch electrodes according to a proportional relationship between second touch electrodes and first touch electrodes in the touch screen; wherein first split second touch electrodes in a same first sub-target second touch electrode are arranged in an extension direction of the second touch electrodes, and second split second touch electrodes in a same second sub-target second touch electrode are arranged in the extension direction of the second touch electrodes;
selecting position coordinates of a first set position in a first target area formed by the first sub-target second touch electrode and the first sub-target first touch electrode as first initial coordinates (x01, y01);
determining first intermediate coordinates (X01′, Y01¹) by using a following first formula group according to the first initial coordinates (x01, y01); wherein (x1ᵢ, y1ᵢ) represents i^{th} center position coordinates in a total number formed by all the first sub-target first touch electrode, all the second sub-target first touch electrode, all the first split second touch electrodes and all the second split second touch electrodes; D1ᵢ represents a distance between the i^{th} center position coordinates and the first initial coordinates, and S1ᵢ represents i^{th} capacitance value;
$$D {1}_{i} = \sqrt{{( x {1}_{i} - {x}_{01} )}^{2} + {( y {1}_{i} - {y}_{01} )}^{2}} ;$$
$$X {01}^{′} = \frac{{\sum }_{i = 1}^{I} \frac{S {1}_{i}}{D {1}_{i}} * x {1}_{i}}{{\sum }_{i = 1}^{I} \frac{S {1}_{i}}{D {1}_{i}}} ;$$
$$Y {01}^{′} = \frac{{\sum }_{i = 1}^{I} \frac{S {1}_{i}}{D {1}_{i}} * y {1}_{i}}{{\sum }_{i = 1}^{I} \frac{S {1}_{i}}{D {1}_{i}}} ;$$
updating the first initial coordinates (x01, y01) according to the determined first intermediate coordinates (X01′, Y01′); and determining new first intermediate coordinates (X01′, Y01′) according to the updated first initial coordinates (x01, y01) by using the first formula group; and updating the first initial coordinates (x01, y01) according to the determined new first intermediate coordinates (X01′, Y01′) until update times satisfy an update threshold, and taking the last updated first initial coordinates (x01, y01) as the target touch position coordinates.

5. The touch positioning method of claim 4, wherein the position coordinates of the first set position are center position coordinates of the first target area.

6. The touch positioning method of claim 2, wherein said determining the target touch position coordinates according to the capacitance values and position coordinates of the target second touch electrodes as well as the capacitance values and position coordinates of the target first touch electrodes, comprises:
among the target second touch electrodes, determining a target second touch electrode with a maximum capacitance value as a third sub-target second touch electrode; and
determining the target touch position coordinates according to the capacitance value and position coordinates of the third sub-target second touch electrode as well as capacitance values and position coordinates of target first touch electrodes adjacent to the third sub-target second touch electrode.

7. The touch positioning method of claim 6, wherein said determining the target touch position coordinates according to the capacitance value and position coordinates of the third sub-target second touch electrode as well as the capacitance values and position coordinates of target first touch electrodes adjacent to the third sub-target second touch electrode, comprises:
among the target first touch electrodes adjacent to the third sub-target second touch electrode, determining a target first touch electrode with a capacitance value greater than the first threshold and less than a second threshold as a third sub-target first touch electrode; and
determining the target touch position coordinates according to the capacitance value and position coordinates of the third sub-target second touch electrode as well as the capacitance value and position coordinates of the third sub-target first touch electrode.

8. The touch positioning method of claim 7, wherein said determining the target touch position coordinates according to the capacitance value and position coordinates of the third sub-target second touch electrode as well as the capacitance value and position coordinates of the third sub-target first touch electrode, comprises:
dividing the third sub-target second touch electrode equally into a plurality of third split second touch electrodes according to a proportional relationship between second touch electrodes and first touch electrodes in the touch screen; wherein third split second touch electrodes in a same third sub-target second touch electrode are arranged in an extension direction of the second touch electrodes;
selecting position coordinates of a second set position in a second target area formed by the third sub-target second touch electrode and the third sub-target first touch electrode as second initial coordinates (x02, y02);
determining second intermediate coordinates (X02′, Y02′) by using a following second formula group according to the second initial coordinates (x02, y02); wherein (x1ₙ, y1ₙ) represents n^{th} center position coordinates in a total number formed by all the third sub-target first touch electrode and all the third split second touch electrodes, D1ₙ represents a distance between the n^{th} center position coordinates and the second initial coordinates, and S1ₙ represents n^{th} capacitance value;
$$D {1}_{n} = \sqrt{{( x {1}_{n} - {x}_{02} )}^{2} + {( y {1}_{n} - {y}_{02} )}^{2}} ;$$
$$X {02}^{′} = \frac{{\sum }_{n = 1}^{N} \frac{S {1}_{n}}{D {1}_{n}} * x {1}_{n}}{{\sum }_{n = 1}^{N} \frac{S {1}_{n}}{D {1}_{n}}} ;$$
$$Y {02}^{′} = \frac{{\sum }_{n = 1}^{N} \frac{S {1}_{n}}{D {1}_{n}} * y {1}_{n}}{{\sum }_{n = 1}^{N} \frac{S {1}_{n}}{D {1}_{n}}} ;$$
updating the second initial coordinates (x02, y02) according to the determined second intermediate coordinates (X02′, Y02′); and determining new second intermediate coordinates (X02′, Y02′) according to the updated second initial coordinates (x02, y02) by using the second formula group; and updating the second initial coordinates (x02, y02) according to the determined new second intermediate coordinates (X02′, Y02′) until update times satisfy an update threshold, and taking the last updated second initial coordinates (x02, y02) as the target touch position coordinates.

9. The touch positioning method of claim 8, wherein the position coordinates of the second set position are center position coordinates of the second target area.

10. (canceled)

11. A non-volatile computer readable storage medium storing a computer program thereon, wherein the computer program, when executed by a processor, implements the touch positioning method of claim 1.

12. A computer device comprising a memory, a processor and a computer program that is stored on the memory and capable to be run on the processor, wherein the processor, when executing the computer program, is configured for:
acquiring capacitance values and position coordinates of each first touch electrode and each second touch electrode in a touch screen;
for the each second touch electrode, judging whether a capacitance value of the second touch electrode is greater than a first threshold;
determining second touch electrodes as target second touch electrodes when judging that capacitance values of the second touch electrodes each is greater than the first threshold; and
determining target touch position coordinates according to the capacitance values and position coordinates of the target second touch electrodes as well as capacitance values and position coordinates of first touch electrodes adjacent to the target second touch electrodes.

13. The touch positioning method of claim 1, wherein a plurality of columns of first touch electrodes and a plurality of columns of second touch electrodes in the touch screen are alternately arranged in a second direction.

14. The touch positioning method of claim 13, wherein:
a column of second touch electrodes comprises a plurality of second electrodes, arranged at intervals in a first direction and each extending in the first direction; and
a column of first touch electrodes comprises a plurality of first touch electrodes, arranged at intervals in the first direction and each extending in the second direction.

15. The touch positioning method of claim 14, one second touch electrode in a column of second touch electrodes corresponds to at least two first touch electrodes in a column first touch electrodes adjacent to the column of second touch electrodes.

16. The computer device of claim 12, wherein the processor is configured for determining target touch position coordinates according to the capacitance values and position coordinates of the target second touch electrodes as well as capacitance values and position coordinates of the first touch electrodes adjacent to the target second touch electrodes, by:
among the first touch electrodes adjacent to the target second touch electrodes, determining first touch electrodes with capacitance values each greater than the first threshold as target first touch electrodes; and
determining the target touch position coordinates according to the capacitance values and position coordinates of the target second touch electrodes as well as capacitance values and position coordinates of the target first touch electrodes.

17. The computer device of claim 16, wherein the processor is configured for determining the target touch position coordinates according to the capacitance values and position coordinates of the target second touch electrodes as well as the capacitance values and position coordinates of the target first touch electrodes, by:
among the target second touch electrodes, determining a target second touch electrode with a capacitance value greater than a second threshold as a first sub-target second touch electrode, and determining a target second touch electrode with a capacitance value not greater than the second threshold as a second sub-target second touch electrode; wherein the second threshold is greater than the first threshold;
among target first touch electrodes adjacent to the first sub-target second touch electrode, determining a target first touch electrode with a capacitance value not greater than the second threshold as a first sub-target first touch electrode; and among target first touch electrodes adjacent to the second sub-target second touch electrode, determining a target first touch electrode with a capacitance value greater than the first threshold as a second sub-target first touch electrode; and
determining the target touch position coordinates according to the capacitance value and position coordinates of the first sub-target second touch electrode, the capacitance value and position coordinates of the first sub-target first touch electrode, the capacitance value and position coordinates of the second sub-target second touch electrode, and the capacitance value and position coordinates of the second sub-target first touch electrode.

18. The computer device of claim 17, wherein the capacitance value of the first sub-target second touch electrode is a maximum value among capacitance values of the target second touch electrodes; and
the processor is configured for determining the target touch position coordinates according to the capacitance value and position coordinates of the first sub-target second touch electrode, the capacitance value and position coordinates of the first sub-target first touch electrode, the capacitance value and position coordinates of the second sub-target second touch electrode, and the capacitance value and position coordinates of the second sub-target first touch electrode, by:
dividing the first sub-target second touch electrode equally into a plurality of first split second touch electrodes and dividing the second sub-target second touch electrode equally into a plurality of second split second touch electrodes according to a proportional relationship between second touch electrodes and first touch electrodes in the touch screen; wherein first split second touch electrodes in a same first sub-target second touch electrode are arranged in an extension direction of the second touch electrodes, and second split second touch electrodes in a same second sub-target second touch electrode are arranged in the extension direction of the second touch electrodes;
selecting position coordinates of a first set position in a first target area formed by the first sub-target second touch electrode and the first sub-target first touch electrode as first initial coordinates (x01, y01);
determining first intermediate coordinates (X01′, Y01′) by using a following first formula group according to the first initial coordinates (x01, y01); wherein (x1ᵢ, y1ᵢ) represents i^{th} center position coordinates in a total number formed by all the first sub-target first touch electrode, all the second sub-target first touch electrode, all the first split second touch electrodes and all the second split second touch electrodes; D1ᵢ represents a distance between the i^{th} center position coordinates and the first initial coordinates, and S1ᵢ represents i^{th} capacitance value;
$$D {1}_{i} = \sqrt{{( x {1}_{i} - {x}_{01} )}^{2} + {( y {1}_{i} - {y}_{01} )}^{2}} ;$$
$$X {01}^{′} = \frac{{\sum }_{i = 1}^{I} \frac{S {1}_{i}}{D {1}_{i}} * x {1}_{i}}{{\sum }_{i = 1}^{I} \frac{S {1}_{i}}{D {1}_{i}}} ;$$
$$Y {01}^{′} = \frac{{\sum }_{i = 1}^{I} \frac{S {1}_{i}}{D {1}_{i}} * y {1}_{i}}{{\sum }_{i = 1}^{I} \frac{S {1}_{i}}{D {1}_{i}}} ;$$
updating the first initial coordinates (x01, y01) according to the determined first intermediate coordinates (X01′, Y01′); and determining new first intermediate coordinates (X01′, Y01′) according to the updated first initial coordinates (x01, y01) by using the first formula group; and updating the first initial coordinates (x01, y01) according to the determined new first intermediate coordinates (X01′, Y01′) until update times satisfy an update threshold, and taking the last updated first initial coordinates (x01, y01) as the target touch position coordinates.

19. The computer device of claim 16, wherein the processor is configured for determining the target touch position coordinates according to the capacitance values and position coordinates of the target second touch electrodes as well as the capacitance values and position coordinates of the target first touch electrodes, by:
among the target second touch electrodes, determining a target second touch electrode with a maximum capacitance value as a third sub-target second touch electrode; and
determining the target touch position coordinates according to the capacitance value and position coordinates of the third sub-target second touch electrode as well as capacitance values and position coordinates of target first touch electrodes adjacent to the third sub-target second touch electrode.

20. The computer device of claim 19, wherein the processor is configured for determining the target touch position coordinates according to the capacitance value and position coordinates of the third sub-target second touch electrode as well as the capacitance values and position coordinates of target first touch electrodes adjacent to the third sub-target second touch electrode, by:
among the target first touch electrodes adjacent to the third sub-target second touch electrode, determining a target first touch electrode with a capacitance value greater than the first threshold and less than a second threshold as a third sub-target first touch electrode; and
determining the target touch position coordinates according to the capacitance value and position coordinates of the third sub-target second touch electrode as well as the capacitance value and position coordinates of the third sub-target first touch electrode.

21. The computer device of claim 20, wherein the processor is configured for determining the target touch position coordinates according to the capacitance value and position coordinates of the third sub-target second touch electrode as well as the capacitance value and position coordinates of the third sub-target first touch electrode, by:
dividing the third sub-target second touch electrode equally into a plurality of third split second touch electrodes according to a proportional relationship between second touch electrodes and first touch electrodes in the touch screen; wherein third split second touch electrodes in a same third sub-target second touch electrode are arranged in an extension direction of the second touch electrodes;
selecting position coordinates of a second set position in a second target area formed by the third sub-target second touch electrode and the third sub-target first touch electrode as second initial coordinates (x02, y02);
determining second intermediate coordinates (X02′, Y02¹) by using a following second formula group according to the second initial coordinates (x02, y02); wherein (x1ₙ, y1ₙ) represents n^{th} center position coordinates in a total number formed by all the third sub-target first touch electrode and all the third split second touch electrodes, D1ₙ represents a distance between the n^{th} center position coordinates and the second initial coordinates, and S1ₙ represents n^{th} capacitance value;
$$D {1}_{n} = \sqrt{{( x {1}_{n} - {x}_{02} )}^{2} + {( y {1}_{n} - {y}_{02} )}^{2}} ;$$
$$X {02}^{′} = \frac{{\sum }_{n = 1}^{N} \frac{S {1}_{n}}{D {1}_{n}} * x {1}_{n}}{{\sum }_{n = 1}^{N} \frac{S {1}_{n}}{D {1}_{n}}} ;$$
$$Y {02}^{′} = \frac{{\sum }_{n = 1}^{N} \frac{S {1}_{n}}{D {1}_{n}} * y {1}_{n}}{{\sum }_{n = 1}^{N} \frac{S {1}_{n}}{D {1}_{n}}} ;$$
updating the second initial coordinates (x02, y02) according to the determined second intermediate coordinates (X02′, Y02′); and determining new second intermediate coordinates (X02′, Y02′) according to the updated second initial coordinates (x02, y02) by using the second formula group; and updating the second initial coordinates (x02, y02) according to the determined new second intermediate coordinates (X02′, Y02′) until update times satisfy an update threshold, and taking the last updated second initial coordinates (x02, y02) as the target touch position coordinates.
